(19) United States
(12) Patent Application Publication
(10) Pub. No.: US 2011/0233175 A1
(43) Pub. Date: Sep. 29, 2011

(54) PICK-AND-PLACE MACHINE

(75) Inventors: Adrianus Johannes Petrus Maria Vermeer, Geldrop (NL); Jacques Cor Johan van der Donck, Alphen aan den Rijn (NL); Clemens Maria Bernardus van der Zon, 's-Hertogenbosch (NL); Erwin John van Zwet, Pijnacker (NL); Robert Snel, Delft (NL); Pieter Willem Herman de Jager, Rotterdam (NL)

(73) Assignee: Nederlandse Organisatie voor toegepast- natuurwetenschappelijk onderzoek TNO, Delft (NL)

(21) Appl. No.: 13/060,690

(22) PCT Filed: Sep. 1, 2009
(86) PCT No.: PCT/NL2009/050523

§ 371 Date: Jun. 20, 2011

(30) Foreign Application Priority Data
Sep. 1, 2008 (EP) 08163401.6

(51) Int. Cl. B65G 49/05; B65G 57/02; B23K 26/00

(52) U.S. Cl. 219/121.6; 414/222.01; 414/802

(57) ABSTRACT

A pick-and-place machine, comprising: a pick station; a place station; a pick/place head for transporting a die from the pick station along a transport path to the place station; wherein the machine further comprises a die-face processing means, comprising an inspection unit and/or a cleaning unit, operable to process a face of the die on the transport path.

The present invention relates to a pick-and-place machine having particular application to the manufacture of three dimensional integrated circuits (3D ICs).

It is well known that pick-and-place machines are used to place a broad range of electronic components onto substrates, such as printed circuit boards. In a conventional back-end manufacturing setting, particle contamination is hardly a problem. Only in the extreme case in which contaminating particles clog around the bond pads might the welding of the bond wires or the soldering of the flip chip interconnects be impaired.

With the advent of 3D ICs, the performance bar for pick-and-place machines has been raised considerably. In manufacturing 3D ICs of the die-to-wafer and die-to-die varieties, it is necessary to create a stack of dies which is sufficiently precisely positioned to permit electrical interconnection between the dies in the stack by Through Silicon Vias (TSVs). The TSVs connect through bumps with a size of 1-2 microns. As a consequence, a stand-off distance between dies in the order of 1 micron is required. If a die surface is contaminated with a particle larger than the stand-off distance, the die cannot be located such that the TSVs make electrical contact and a non-functioning stack results. Such contamination has a disproportionate impact on the yield of functioning stacks, since contamination of any one die in the stack may result in a non-functioning stack.

It is an object of the present invention to provide a pick-and-place machine which tackles contamination to enable commercially-viable high yield 3D IC manufacture.

With this in mind, according to a first aspect, the present invention may provide a pick-and-place machine, comprising:

a pick station;

a place station;

a pick/place head for transporting a die from the pick station along a transport path to the place station;

wherein the machine further comprises a die-face processing means, comprising an inspection unit and/or a cleaning unit, operable to process a face of the die on the transport path.

By providing for the inspection and/or cleaning of a die face on the transport path, that is after the die has been picked and before it has been placed, the present invention increases the probability that an individual die will be successfully placed, thereby increasing functioning stack yields.

In one embodiment, the die-face processing means comprises the inspection unit only. In another embodiment, the die-face processing means comprises the cleaning unit only. In a preferred embodiment, the die-face processing means advantageously comprises both the inspection unit and the cleaning unit. In the preferred embodiment, the die can be cleaned by the cleaning unit and then inspected for extant contamination by the inspection unit. If there is any extant contamination, the die can be discarded, or alternatively, cleaned and inspected again.

According to a second aspect, the present invention may comprise a method for creating a stack of dies in the manufacture of a three dimensional integrated circuit using a pick-and-place machine, comprising:

picking a die from a pick station which starts a pick-and-place cycle;

transporting the first die to a place station for placement onto a destination stack which terminates the pick-and-place cycle;

inspecting and/or cleaning a face of the die during the pick-and-place cycle.

Preferably, during the pick operation or during the pick-and-place cycle, inspecting and/or cleaning a face of a further die that is uppermost in the destination stack.

Inspecting and/or cleaning the relevant faces of said die and said further die before stacking helps to ensure that the placement is successful.

Other aspects and further preferred features of the present invention are described in the following description and defined in the appended claims.

Exemplary embodiment of the present invention are hereinafter described with reference to the accompanying drawings, in which:

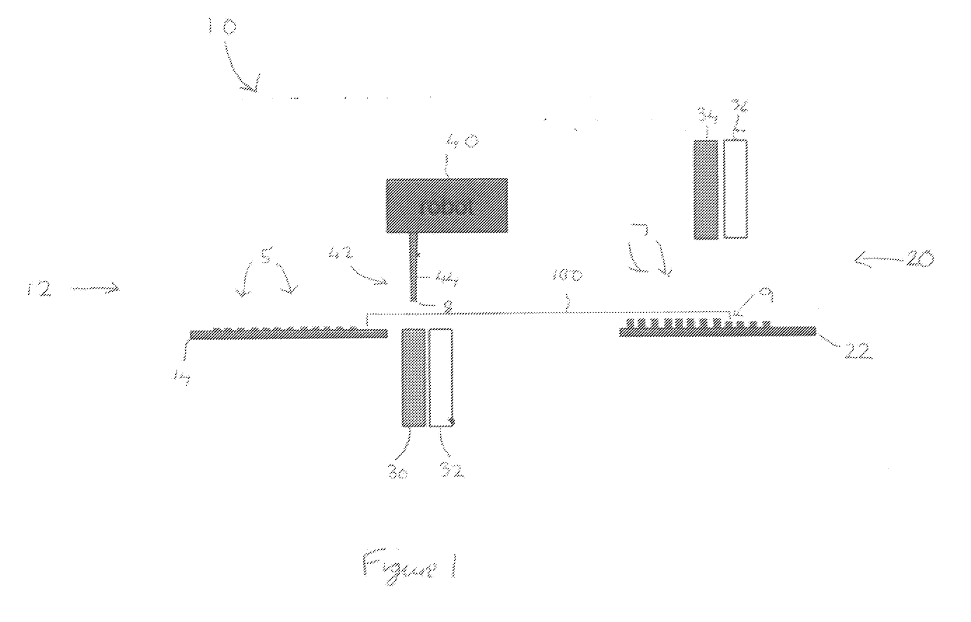

FIG. 1 shows the layout of a first pick-and-place machine;

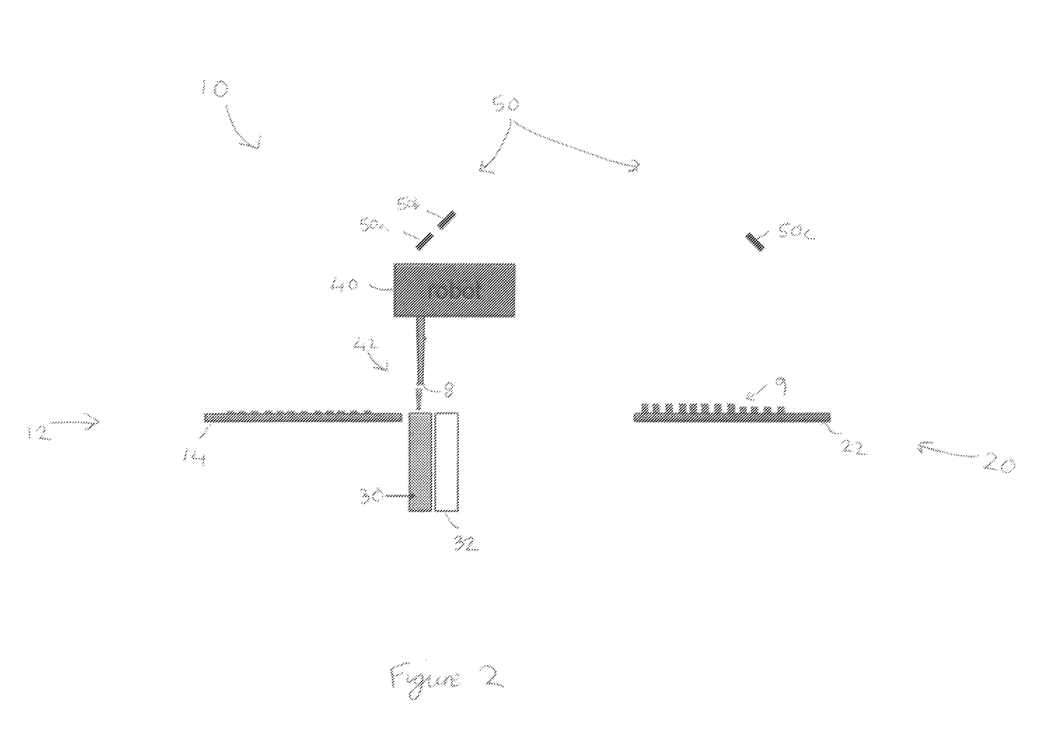

FIG. 2 shows the layout of a second pick-and-place machine;

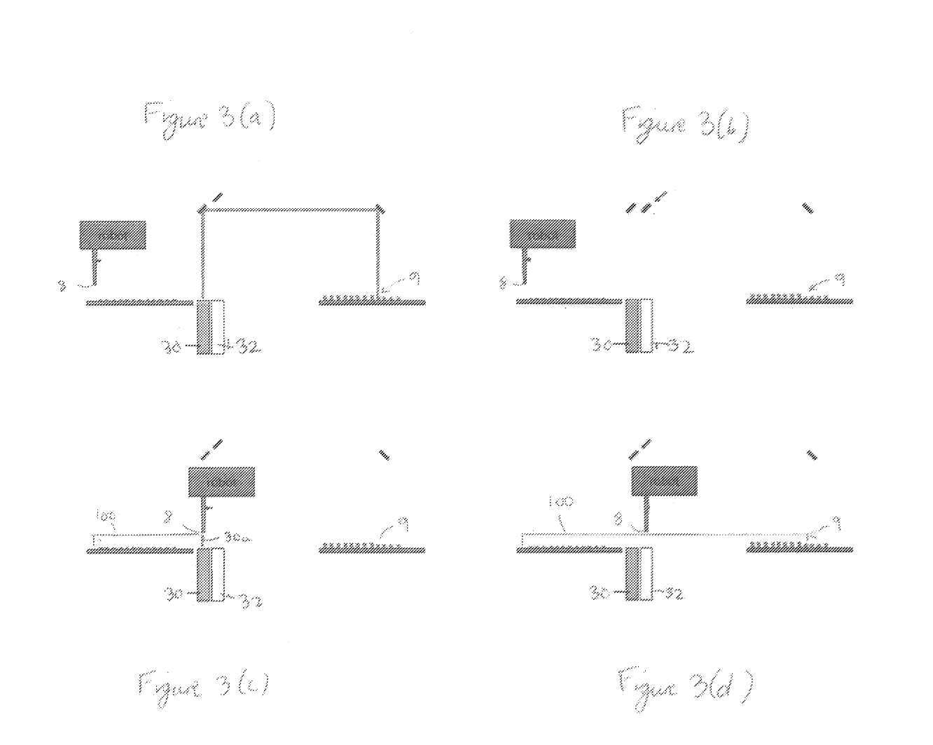

FIGS. 3(a), (b), (c), (d) show the second pick-and-place machine in operation at various instances in the process; and

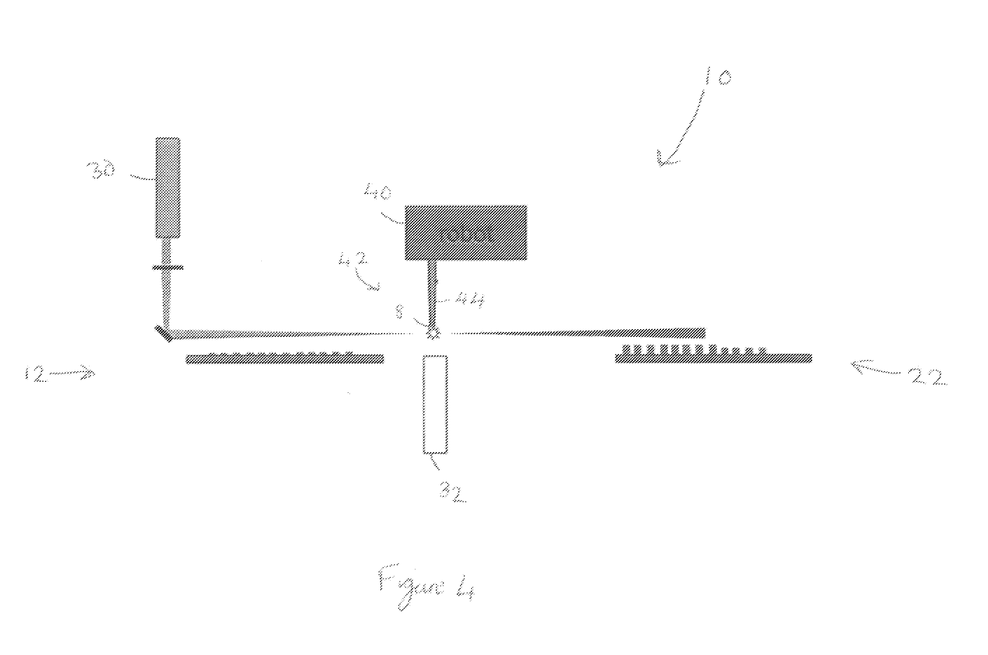

FIG. 4 shows the layout of a third pick-and-place machine.

A first pick-and-place machine generally designated 10 is shown in FIG. 1.

The machine 10 comprises a pick station 12 which includes a substrate in the form of a pick-up wafer 14. The pick-up wafer 14 contains an array of dies 5 for use in 3D IC manufacture. The pick station 12 holds the pick-up wafer 14 such that the dies 5 are presented in, a horizontal orientation ready for picking. The machine 10 further comprises a place station 20 which includes a substrate in the form of a target wafer 22. The place station 20 holds the target wafer 22 in a horizontal orientation. The target wafer 22 hosts stacks 7 of dies as they are being created.

The machine 10 further comprises a first cleaning unit 30 including a laser and a first inspection unit 32 including a camera unit, both units 30, 32 being situated adjacent to the pick station 12 and intermediate the pick station 12 and the place station 14. The machine 10 further comprises a second cleaning unit 34 including a laser and a second inspection unit 36 including a camera unit, both units 34, 36 being situated above the target wafer 22.

The machine 10 further comprises a transport robot 40 moveable between the pick station 12 and the place station 14. The robot 40 comprises a pick/place head 42, having a collet 44, for picking and placing a die 5.

In operation, the robot 40 is positioned over the pick-up wafer 14. To start the current pick-and-place cycle, a particular die, designated 8, is picked up via its top face by the pick/place head 42. The robot 40 then starts to move the die 8 along a transport path to a destination stack designated 9 at the target wafer 22. A typical transport path 100 is illustrated in FIG. 1. Partway along the transport path, the robot 40 stops and the bottom face of the die 8 that is intended to abut the upper face of the die uppermost in the destination stack 9 on placement of the die, is prepared for that placement by the following processing steps. First, the first cleaning unit 30 by means of a beam (not shown) from a laser performs a direct cleaning operation of the bottom face of the die 8. The cleaning operation is intended to achieve the removal of particles of at least 500 nm and larger and, preferably, 100 nm and larger.

Next, the first inspection unit 32 performs an optical inspection of the bottom face of the die 8 using a bright and dark field imaging technique to verify that the bottom face of the die 8 is free of surface contamination, at least to the extent that would interfere with the formation of functioning stacks as mentioned earlier, and also to identify other quality impairing artifacts such as chipping, missing balls and cracks. If the inspection reveals extant contamination, the cleaning may be repeated. If the inspection is failed on a number of occasions, the die 8 may be discarded and a replacement fetched from the pick-up wafer 14. Having passed inspection the die 8 is transported on to the place station 20. During the pick-and-place cycle, at some time before the die 8 reaches the place station 20, the top face of the die at the uppermost in the destination stack 9 is prepared to receive the die 8 by processing steps performed by the second cleaning unit 34 and the second inspection unit 36. The processing steps performed by the second cleaning unit 34 and the second inspection unit 36 may be the same as those performed by the first cleaning unit 30 and the first inspection unit 32.

With the bottom face of the transported die 8 and the top face of the die at the uppermost in the destination stack 9 having been pre-processed in the manner described, the probability that the die 8 is successfully placed is high. As each die in a stack is placed in the same manner, then the yield of functioning stacks can also be expected to be high.

When subsequently, parts similar to those described in relation to the first pick-and-place machine shown in FIG. 1 are referred to, the same reference numeral is used.

A second pick-and-place machine 10 is shown in FIG. 2. The second pick-and-place machine differs from the first pick-and-place machine in that an adjustable optical assembly 50 enables the first cleaning unit 30 and the first inspection unit 32 to handle the processing of both the bottom face of the transported die and the top face of the die at the uppermost in the destination stack, whereby the second cleaning unit 34 and the second inspection unit 36 may be dispensed with. The optical assembly 50 comprises a plurality of adjustable mirrors 50a, 50b, 50c.

The operation of the second pick-and-place machine 10 is now explained with reference to FIGS. 3(a), (b), (c), (d). In FIG. 3(a), the pick/place head 42 picks up the die 8. Simultaneously with the performance of the pick operation, the optical assembly 50 is adjusted such that a laser beam 30a from the first cleaning unit 30 is directed to the die at the uppermost in the destination stack 9. After cleaning the top face of the die at the uppermost in the destination stack 9, the optical assembly 50 is adjusted such that the first inspection unit 32 can perform an optical inspection of that face as shown in FIG. 3(b). Next, as shown in FIG. 3(c), the robot 40 moves the die 8 along the transport path 100 to a position in which the bottom face of the die 8 is cleaned. Next, as shown in FIG. 3(d), the result of the cleaning operation is verified by visual inspection using the first inspection unit 32. The placement of the die 8 onto the stack 9 is then performed.

In a variant of the second pick-and-place machine 10, the first cleaning unit 30 and the first inspection unit 32 use a different light path. In such a case, each unit 30, 32 may be provided with an individual optical assembly.

A third pick-and-place machine 10 is shown in FIG. 4. The third pick-and-place machine 10 differs from the second pick-and-place machine in that the cleaning unit 30 is configured to perform a cleaning operation by shockwave cleaning.

In other embodiments, the cleaning units 30, 34 may clean by nano spray/ocean spray, megasonic cleaning, high voltage cleaning, wet laser cleaning/steam laser cleaning, liquid jet, cleaning by ultrasonic nozzle, brushing, laser ablation, scrubbing (PVA+UPW), CO₂ snow, air knife/air jet or combinations thereof. If a wet cleaning technique is used, the die 8 must be dried before placing. Suitable drying techniques include light (visible of IR), laser (visible of IR), microwave technology, air knife, hot air or combinations thereof.

In other embodiments, the inspection units 32, 36 may, instead of bright and dark field imaging, use other optical inspection and metrology techniques.

In other embodiments, instead of a robot 40, the pick/place head 42 may be moved by a rotating turret.

1. A pick-and-place machine, comprising:
a pick station;
a place station;
a pick/place head for transporting a die from the pick station along a transport path to the place station;
wherein the machine further comprises a die-face processing means, comprising an inspection unit and/or a cleaning unit, operable to process a face of the die on the transport path.

2. A machine as in claim 1, wherein the die-face processing means comprises the inspection unit only.

3. A machine as in claim 1, wherein the die-face processing means comprises the cleaning unit only.

4. A machine as in claim 1, wherein the die-face processing means comprises the inspection unit and the cleaning unit.

5. A machine as in claim 1, wherein the die-face processing means is further operable to process the face of a further die located at the place station.

6. A machine as in claim 5, further comprising an adjustable optical assembly via which the face of the further die is processed by the die-face processing means.

7. A machine as in claim 1, further comprising a further die-face processing means, comprising an inspection unit and/or a cleaning unit, operable to process the face of a further die located at the place station while said pick/place head is on the transport path or performing a pick operation.

8. A machine as in claim 5, arranged such that the processed face of said die is placed on the processed face of said further die.

9. A machine as in claim 1, further comprising a robot for moving the pick/place head along the transport path.

10. A machine as in claim 1, further comprising a rotary turret to which the pick/place head is mounted for moving the pick/place head along the transport path.

11. A machine as in claim 3, wherein a said cleaning unit comprises a laser operable to perform direct laser cleaning or laser shockwave cleaning.

12. A machine as in claim 3, wherein a said cleaning unit comprises means for performing an optical or non-optical wet cleaning operation.

13. A machine as in claim 12, wherein the machine further comprises a drying means for drying a cleaned die face prior to placement.

14. A method for creating a stack of dies in the manufacture of a three dimensional integrated circuit using a pick-and-place machine, comprising:
picking a die from a pick station which starts a pick-and-place cycle;
transporting the first die to a place station for placement onto a destination stack which terminates the pick-and-place cycle;
inspecting and/or cleaning a face of the die during the pick-and-place cycle.

15. A method as in claim 14, further comprising during the pick operation or during the pick-and-place cycle, inspecting and/or cleaning a face of a further die that is uppermost in the destination stack.

16. A pick-and-place machine, comprising:
a pick station;
a place station; and
a pick/place head for transporting a die from the pick station along a transport path to the place station,
wherein the machine further comprises a die-face processor, comprising at least one of an inspection unit and a cleaning unit, operable to process a face of the die on the transport path.

17. A machine as in claim 16, further comprising a second die-face processor, comprising an inspection unit and/or a cleaning unit, operable to process the face of a further die located at the place station while said pick/place head is on the transport path or performing a pick operation.

18. A machine as in claim 16, further comprising a robot for moving the pick/place head along the transport path.

19. A machine as in claim 16, further comprising a rotary turret to which the pick/place head is mounted for moving the pick/place head along the transport path.
